(19) United States
(12) Patent Application Publication
(10) Pub. No.: US 2025/0325984 A1
(43) Pub. Date: Oct. 23, 2025

(54) MICROFLUIDIC CHIP AND MICROFLUIDIC CHIP OPERATION SYSTEM

(71) Applicant: Taipei Medical University (TMU), Taipei City (TW)

(72) Inventor: Ching-Kuo LEE, Taipei City (TW)

(21) Appl. No.: 19/176,198

(22) Filed: Apr. 11, 2025

(30) Foreign Application Priority Data
Apr. 12, 2024 (TW) 113113867

(51) Int. Cl. B01L 3/00

(52) U.S. Cl. CPC B01L 3/502753; B01L 2200/16; B01L 2300/0681; B01L 2300/087; B01L 2300/0883; B01L 2400/0487; B01L 2400/0633

(57) ABSTRACT

A microfluidic chip includes: a sample loading chamber, a processing chamber, a first filtering element, a chromatography column, a liquid channel system, and a detection region which are sequentially communicated. The microfluidic chip further includes: a first valve element, a second valve element, and an actuation element. The first valve element is disposed between the sample loading chamber and the processing chamber. The second valve element is disposed between the processing chamber and the first filtering element. The actuation element is disposed over the processing chamber and includes a driving membrane, configured to generate vortices in the processing chamber and control the pressure within the processing chamber.

### CROSS-REFERENCE TO RELATED APPLICATION

This application claims priority to Taiwan Application Serial Number 113113867, filed Apr. 12, 2024, which is herein incorporated by reference in its entirety.

### BACKGROUND

### Field of Invention

The present disclosure relates to a microfluidic chip for extracting compounds from a sample and the associated microfluidic chip operation system.

### Description of Related Art

When detecting substances contained in biological or chemical samples, it is often necessary to first separate and purify specific compounds due to the complexity of the samples. In conventional extraction and separation process, the samples are first extracted with an extraction solvent, followed by separation and purification to obtain compounds for subsequent detection, such as determining the types or characteristics of the compounds in the samples. However, these conventional operations of extracting and separating compounds often require large amounts of sample material and consume significant amounts of reagents, consumables, and labor.

### SUMMARY

In light of the above issues, one of the objectives of the present disclosure is to provide a microfluidic chip and a microfluidic chip operation system that integrates the extraction and separation of compounds from samples into a single microfluidic chip.

Some embodiments of the present disclosure provide a microfluidic chip, including: a sample loading chamber, a processing chamber, a first filtering element, a chromatography column, a liquid channel system, and a detection region, which are sequentially communicated. The microfluidic chip further includes: a first valve element, a second valve element, and an actuation element. The first valve element is disposed between the sample loading chamber and the processing chamber. The second valve element is disposed between the processing chamber and the first filtering element. The actuation element is disposed over the processing chamber, wherein the actuation element includes a driving membrane and is configured to generate a vortex in the processing chamber and control the pressure within the processing chamber.

In some embodiments, the first valve element includes a first valve pillar having an opening size ranging from about 5 micrometers to about 30 micrometers.

In some embodiments, the lower surface of the driving membrane has an uneven structure. In some embodiments, the uneven structure includes recessed portions. In some embodiments, the depth of the recessed portions is about ⅓ to about ⅔ of the thickness of the driving membrane.

In some embodiments, the microfluidic chip further includes: a heating element disposed under the processing chamber.

In some embodiments, the microfluidic chip further includes: a weighing element disposed under the processing chamber.

In some embodiments, the microfluidic chip further includes: a second filtering element disposed between the chromatography column and the liquid channel system.

In some embodiments, the detection region includes a plurality of first micropores.

In some embodiments, the detection region includes a plurality of sub-detection regions. Each of the sub-detection regions includes at least one micropore.

In some embodiments, the detection region includes a first sub-detection region, a second sub-detection region, a third sub-detection region, and a fourth sub-detection region. The first sub-detection region includes a plurality of first micropores. The second sub-detection region includes a plurality of second micropores. The third sub-detection region includes a plurality of third micropores. The fourth sub-detection region includes a plurality of fourth micropores.

In some embodiments, the liquid channel system includes: a main channel and a plurality of primary branch channels. In some embodiments, the main channel is connected to the plurality of primary branch channels. In some embodiments, each of the plurality of primary branch channels is connected to a plurality of secondary branch channels.

In some embodiments, cells, antibodies, signal detection elements, or combinations thereof are disposed in the plurality of first micropores.

In some embodiments, the microfluidic chip further includes: a reagent addition/sampling channel and a third valve element. The reagent addition/sampling channel is in communication with the chromatography column. The third valve element is configured to control a liquid flow direction, opening, or closing of the reagent addition/sampling channel.

In some embodiments, the microfluidic chip further includes: a waste liquid channel and a fourth valve element. The waste liquid channel is in communication with the chromatography column. The fourth valve element is configured to control the opening or closing of the waste liquid channel.

In some embodiments, in the microfluidic chip, the first valve element, the second valve element, and the actuation element are controlled via gas pressure.

In some embodiments, the microfluidic chip is a stacked structure, including: a substrate layer, a first channel layer, and a second channel layer. The first channel layer is disposed over the substrate layer, wherein a plurality of recesses for liquid flow are defined in the first channel layer. The second channel layer is disposed over the first channel layer, wherein a plurality of recesses for gas flow are defined in the second channel layer.

In some embodiments, the first channel layer includes a plurality of first openings, the second channel layer includes a plurality of second openings corresponding to the first openings, and the first openings and second openings define a plurality of liquid storage regions.

In some embodiments, a first filter of the first filtering element is disposed in a first filter cavity formed by a first filter recess of the first channel layer and a second filter recess of the second channel layer. A second filter of the second filtering element is disposed in a second filter cavity formed by a third filter recess of the first channel layer and a fourth filter recess of the second channel layer.

In some embodiments, the microfluidic chip further includes: a heating and weighing assembly. The heating and weighing assembly is disposed in the substrate layer and at the bottom of the processing chamber.

In some embodiments, in the microfluidic chip, the actuation element includes a driving membrane and a driving control recess over the driving membrane.

In some embodiments, the first channel layer includes a processing chamber recess and a driving membrane on the processing chamber recess, with the position of the processing chamber recess corresponding to the processing chamber. The second channel layer includes a driving control recess.

In some embodiments, the actuation element further includes a driving control recess, the driving control recess is over the driving membrane, wherein the processing chamber and the driving membrane are disposed in the first channel layer, and the driving control recess is disposed in the second channel layer.

In some embodiments, in the microfluidic chip, the second channel layer further includes: a driving gas channel and a driving gas vent. The driving gas channel is in communication with the driving control recess. The driving gas vent is in communication with the driving gas channel.

In some embodiments, in the microfluidic chip, the first valve element includes a first valve pillar, a first elastic membrane, and a first valve control recess. The first valve pillar is disposed between the sample loading chamber and the processing chamber and is disposed in the first channel layer. The first elastic membrane is disposed above the first valve pillar and is disposed in the first channel layer. The first valve control recess is disposed over the first valve pillar and the first elastic membrane and is disposed in the second channel layer.

In some embodiments, in the microfluidic chip, the second channel layer further includes: a first valve gas channel and a first valve gas vent. The first valve gas channel is in communication with the first valve control recess. The first valve gas vent is in communication with the first valve gas channel.

In some embodiments, in the microfluidic chip, the chromatography column is disposed in the second channel layer.

In some embodiments, in the microfluidic chip, the first channel layer includes a first sample loading opening, the second channel layer includes a second sample loading opening, and the positions of the first and second sample loading openings correspond to the sample loading chamber.

In some embodiments, the detection region includes a plurality of first micropores. The first channel layer includes a plurality of first micro-through holes. The second channel layer includes a plurality of second micro-through holes, wherein the first micropores correspond to the first and second micro-through holes.

In some embodiments, in the microfluidic chip, the volume of the sample loading chamber is greater than the volume of the processing chamber.

In some embodiments, in the microfluidic chip, the lower surface of the driving membrane has a plurality of patterns configured to enhance turbulence, the plurality of patterns including recessed portions, protruding portions, or combinations thereof.

Some embodiments of the present disclosure provide a microfluidic chip operation system, including: the microfluidic chip as described in the above and following embodiments, an actuation element driving module, and a valve driving module. The actuation element driving module is configured to control the upward and pressed down of the actuation element of the microfluidic chip. The valve driving module is configured to control the opening or closing of the first valve element and the second valve element.

In some embodiments, in the microfluidic chip operation system, the actuation element driving module is configured to control the deformation of the driving membrane of the actuation element using gas pressure, such as raising or pressing down.

In some embodiments, in the microfluidic chip operation system, the valve driving module is configured to control the opening or closing of the first valve element and the second valve element using gas pressure.

In some embodiments, the microfluidic chip operation system further includes: a waste liquid collection module and a reagent addition module. The waste liquid collection module is configured to collect effluent liquid from the chromatography column. The reagent addition module is configured to add reagents to the inflow/outflow channel.

In some embodiments, the microfluidic chip operation system further includes a detection instrument. The detection instrument is used to detect the fluid from the chromatography column or the detection region.

In some embodiments, the detection instrument is a mass spectrometry or a chromatograph. For example, inductively coupled plasma mass spectrometry, liquid chromatograph, or gas chromatograph.

### BRIEF DESCRIPTION OF THE DRAWINGS

The present disclosure is best understood from the following detailed description when read with the accompanying figures. It is emphasized that, in accordance with the standard practice in the industry, various features are not drawn to scale and are used for illustration purposes only. In fact, the dimensions of the various features may be arbitrarily increased or reduced for clarity of discussion. To make the aforementioned and other purposes, features, advantages, and embodiments of this disclosure more apparent and understandable, the descriptions of the accompanying figures are as follows:

FIG. 1 is a perspective view of a microfluidic chip according to some embodiments.

FIG. 2 is a top view of the microfluidic chip according to some embodiments.

FIG. 3 is an exploded view of the microfluidic chip according to some embodiments.

FIG. 4 is a top view of the substrate layer of the microfluidic chip according to some embodiments.

FIG. 5 is a top view of the first channel layer of the microfluidic chip according to some embodiments.

FIG. 6 is a top view of the second channel layer of the microfluidic chip according to some embodiments.

FIG. 7 is a layout of the stacked structure of the microfluidic chip according to some embodiments.

FIGS. 8A to 8C are cross-sectional views along line A-B and line B-C of the microfluidic chip in FIG. 7 during extraction, according to some embodiments.

FIG. 9A illustrates a bottom view of the driving membrane according to some embodiments, according to some embodiments.

FIG. 9B illustrates a cross-sectional view of the driving membrane in FIG. 9A along line F-F′, according to some embodiments.

FIG. 9C illustrates a bottom view of the driving membrane according to other embodiments.

FIG. 10 illustrates is a cross-sectional view along line D-D′ of the microfluidic chip in FIG. 7.

FIG. 11 illustrates a cross-sectional view along line E-E′ of the microfluidic chip in FIG. 7.

FIG. 12 illustrates a schematic diagram of the microfluidic chip operation system according to some embodiments.

FIG. 13 illustrates a flowchart of a method for using the microfluidic chip according to some embodiments.

### DETAILED DESCRIPTION

It is to be understood that the following disclosure provides many different embodiments, or examples, for implementing different features of the disclosure. Specific embodiments or examples of components and arrangements are described below to simplify the present disclosure. These are, of course, merely examples and are not intended to be limiting. For example, dimensions of elements are not limited to the disclosed range or values, but may depend upon process conditions and/or desired properties of the device. Moreover, the formation of a first feature over or on a second feature in the description that follows may include embodiments in which the first and second features are formed in direct contact, and may also include embodiments in which additional features may be formed interposing the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper”, “top,” “higher”, and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

Ordinal terms such as “first,” “second,” etc., used in the present disclosure are intended to modify elements and do not imply any prior order or sequence of the elements, nor the order of manufacturing methods. The use of these ordinal terms is solely to distinguish one element with a certain name from another element with the same name. The claims and the specification may not use the same ordinal terms, so a “first component” in the specification may be referred to as a “second component” in the claims.

Microfluidics refers to the science and technology involved in systems that use microchannels to process or manipulate minute fluids. Due to features such as miniaturization and integration, microfluidic devices are often referred to as microfluidic chips.

Biological or chemical materials often contain complex mixtures. To separate active ingredients having specific effects, such as extracting secondary metabolites (e.g., flavonoids, polysaccharides, volatile oils, quinones, terpenes, saponins, alkaloids, pigments, coumarins, cardiac glycosides, phenolic acids, etc.) from plants and screening for specific compounds having therapeutic effects, it is often necessary to perform steps such as separation, purification, refining, concentration, drying and etc., followed by cell or animal experiments. However, these steps often require large amounts of raw materials, reagents, consumables, labor, and time. In contrast, some embodiments of the present disclosure integrate multiple operations of sample extraction and compound separation into a single microfluidic chip, and the separated compounds may be directly used for detection. In some embodiments, detection, such as cell response detection, may also be performed on the microfluidic chip, allowing extraction, compound separation, and active ingredient screening to be completed on a single chip.

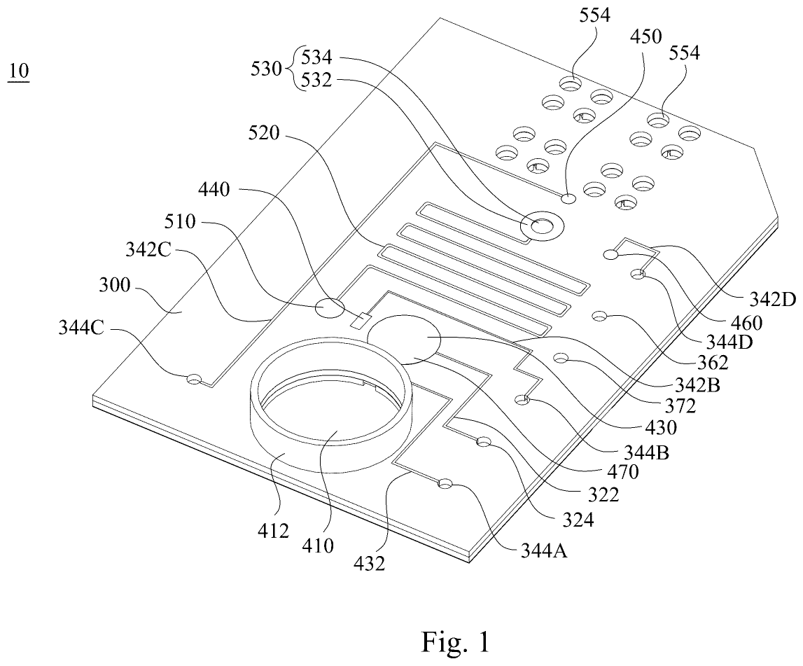

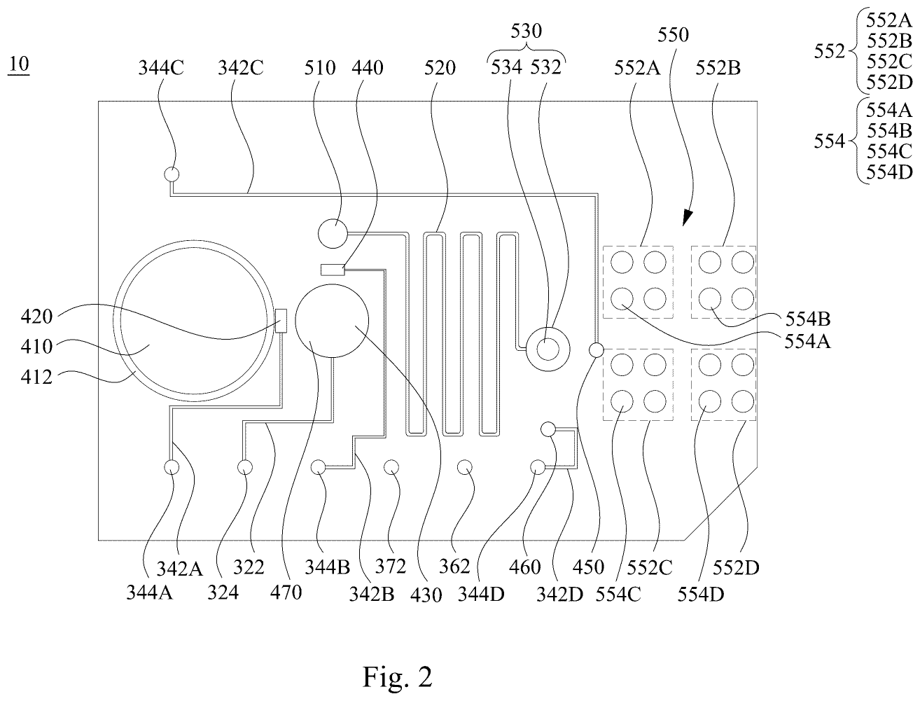

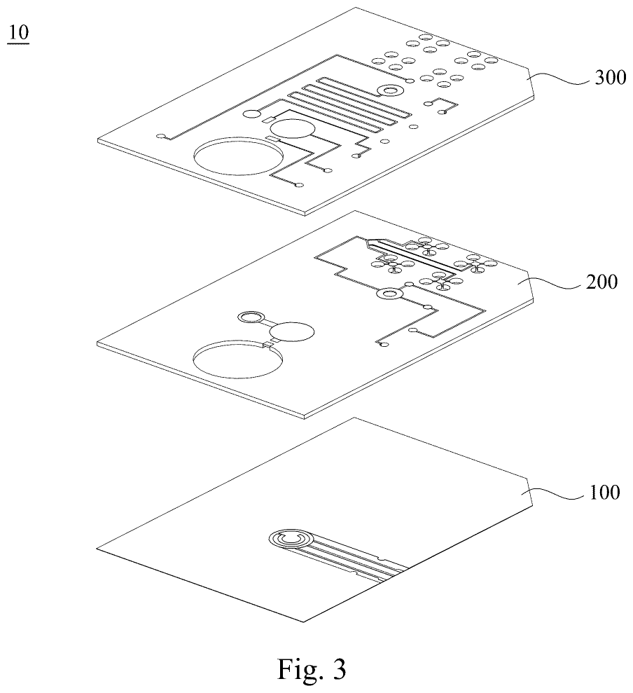

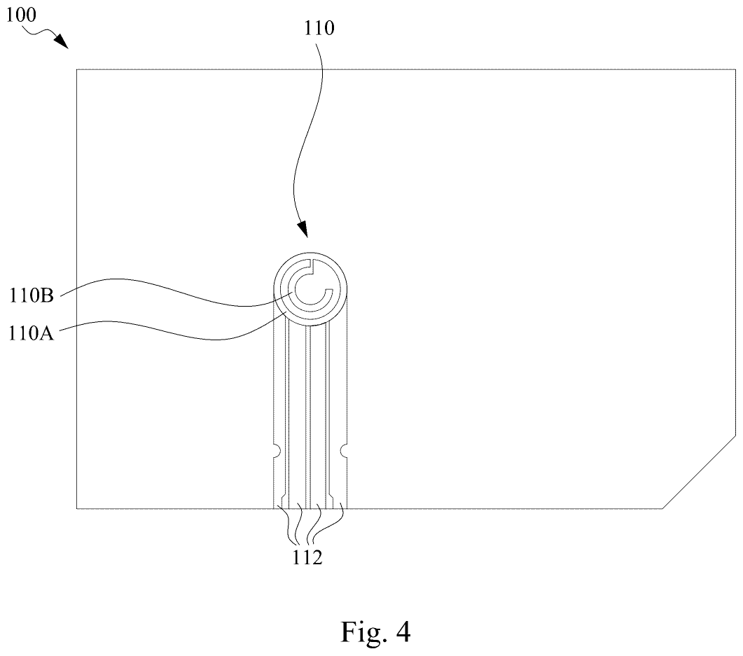

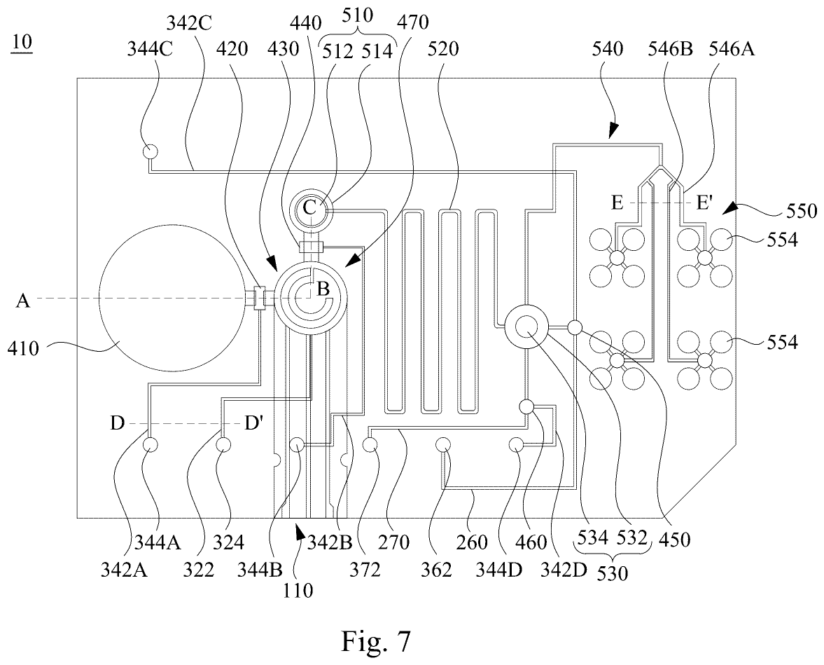

Referring to FIGS. 1 to 7, a microfluidic chip according to some embodiments is illustrated. FIG. 1 is a perspective view of the microfluidic chip 10, FIG. 2 is a top view of the microfluidic chip 10, FIG. 3 is an exploded view of the microfluidic chip 10, FIGS. 4 to 6 are top views of each layer of the microfluidic chip 10, and FIG. 7 is a top view layout of the various layers of the microfluidic chip 10. The microfluidic chip 10 includes a sample loading chamber 410, a first valve element 420, a processing chamber 430, a second valve element 440, a first filtering element 510, a chromatography column 520, a second filtering element 530, a liquid channel system 540, and a detection region 550, which are sequentially communicated. The arrangement of these communicated elements is designed such that after a sample and an extraction solvent are placed in the sample loading chamber 410, the extraction solution may flow into the processing chamber 430 through the opening of the first valve element 420, then into the first filtering element 510 through the opening of the second valve element 440, and subsequently into the chromatography column 520. Compounds with affinity for the filling material in the chromatography column 520 will remain in the chromatography column 520 and can be eluted with a washing solution. The separated compounds then flow out, pass through the second filtering element 530, and then enter the liquid channel system 540. Subsequently, the separated compounds are delivered to the micropores in the detection region for subsequent characteristic detection.

The microfluidic chip 10 further includes an actuation element 470 disposed over the processing chamber 430. The actuation element 470 is configured to drive fluid flow within the microfluidic chip 10. The actuation element 470 includes a driving membrane 280, which is an elastic thin film, when deformed (e.g., raised or pressed down), the pressure in the processing chamber 430 changes, allowing the fluid to flow into or out of the processing chamber 430. In other words, the pressure in the processing chamber 430 can be controlled by the deformation of the driving membrane 280.

After the sample and extraction solvent are placed in the sample loading chamber 410, the first valve element 420 is opened and the second valve element 440 is closed. By controlling the repeated raising and pressing down of the driving membrane 280 of the actuation element 470, the liquid in the sample loading chamber 410 may be repeatedly drawn into and expelled from the processing chamber 430, generating vortices to accelerate the mixing of the sample and extraction solution and the release of components from the sample into the extraction solution. In other embodiments, the sample may be pre-treated, such as using an ultrasonic device to accelerate cell disruption. Since the liquid need to be repeatedly drawn into and expelled from the processing chamber 430 via the pressure generated by the actuation of the driving membrane 280, the volume of the sample loading chamber 410 is set to be larger than that of the processing chamber 430. In some embodiments, the volume of the sample loading chamber 410 is at least 5 or 10 times that of the processing chamber 430.

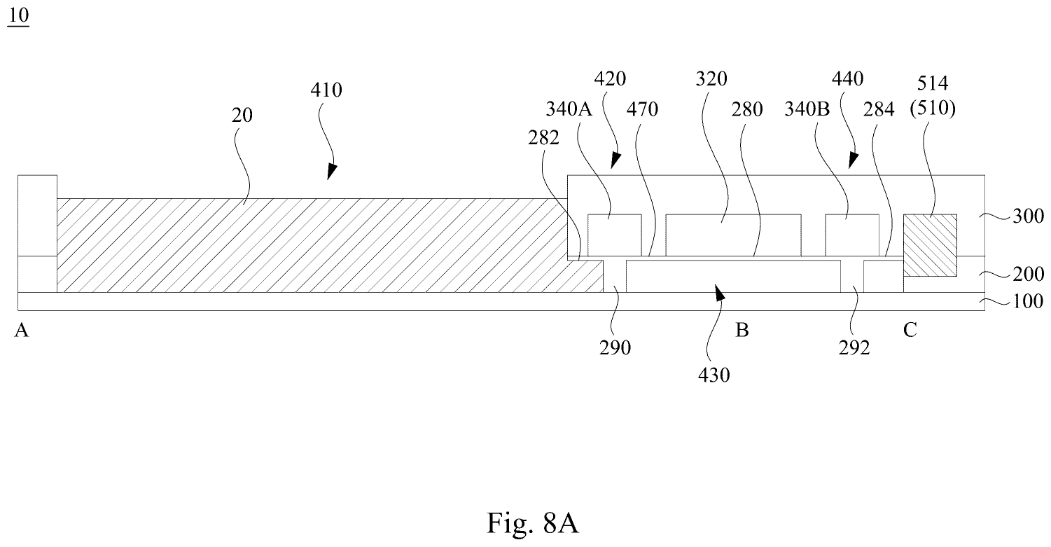

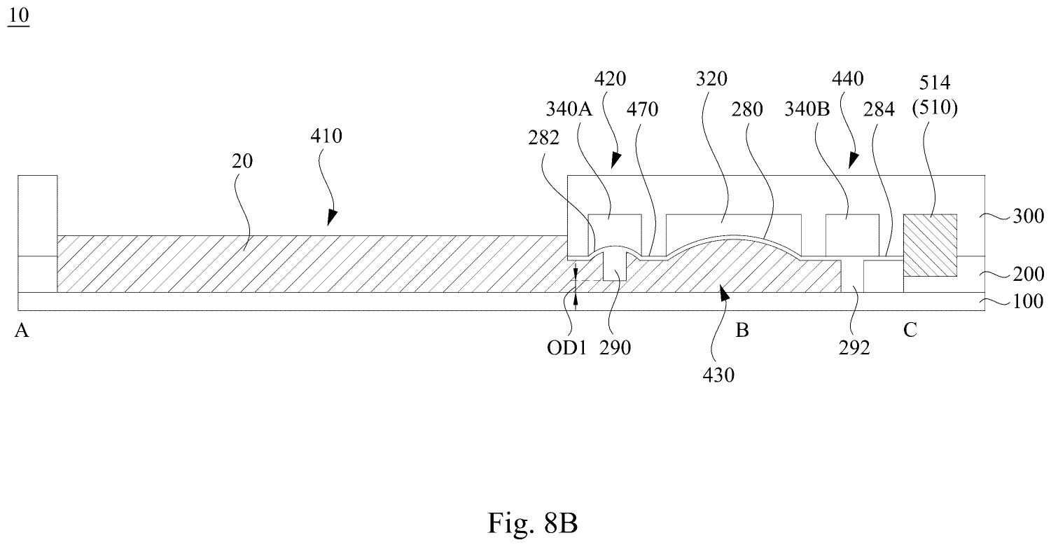

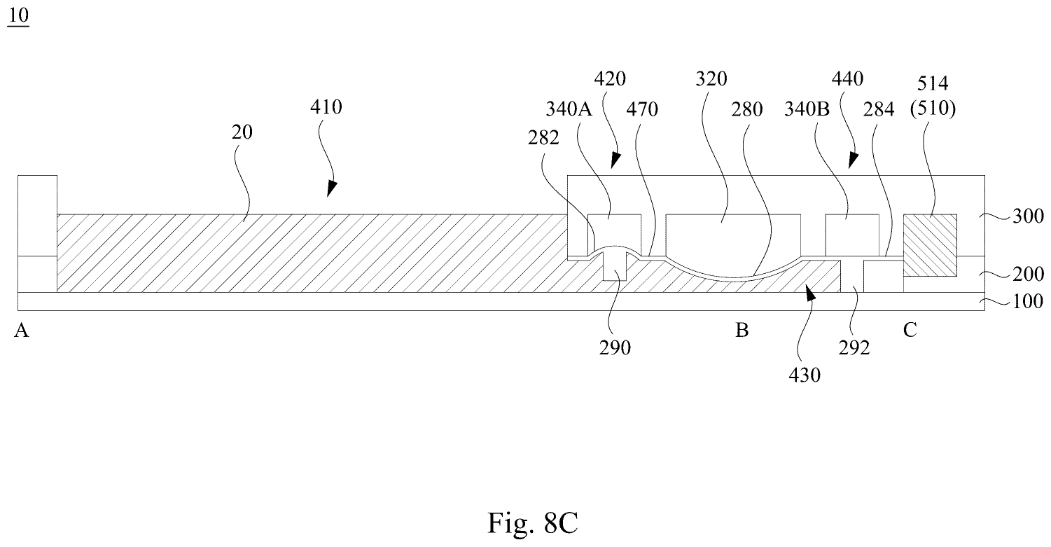

Further, when the liquid flows from the sample loading chamber 410 into the processing chamber 430, the liquid needs to pass through the first valve element 420. Therefore, particles larger than the opening size OD1 of the first valve pillar 290 of the first valve element 420 (see FIG. 8B) cannot enter the processing chamber 430. Thus, the first valve element 420 also provides a filtering effect, preventing tissue debris or fragments from entering the processing chamber 430. In some embodiments, the opening size OD1 of the first valve pillar 290 of the first valve element 420 may range from about 5 micrometers to about 30 micrometers.

In some embodiments, after the components to be extracted are largely dissolved in the extraction solvent, the first valve element 420 is closed, the second valve element 440 is opened, and the pressure generated by the actuation of the driving membrane 280 causes the extraction solution to flow into the first filtering element 510. The first filtering element 510 includes a first filter cavity 512 and a first filter 514 located in the first filter cavity 512, used to filter out smaller residues or impurities in the extraction solution. Subsequently, the pressure generated by the actuation of the driving membrane 280 causes the extraction solution to flow into the chromatography column 520. After chromatographic extraction is completed, the eluate passes through the second filtering element 530. The second filtering element 530 includes a second filter cavity 532 and a second filter 534 located in the second filter cavity 532, used to filter out the beads from the chromatography column 520 that may appear in the eluate.

In some embodiments, as shown in FIGS. 1 to 7, the microfluidic chip 10 further includes a reagent addition/sampling channel 260 and a third valve element 450. The third valve element 450 is configured to control the liquid flow direction, opening, or closing of the reagent addition/sampling channel 260. Optionally, after the eluate containing the compounds flows out of the chromatography column 520, it can be directed to a detection instrument (e.g., a UV absorbance meter, liquid chromatograph, gas chromatograph, inductively coupled plasma mass spectrometry, etc.) via the reagent addition/sampling channel 260 to measure the UV absorbance or component-related signals of the separated compounds.

After the eluate containing the compounds flows out of the chromatography column 520, it enters the micropores 554 in the detection region 550 via the liquid channel system 540. Optionally, reagents required for detection can be added to the detection region 550 via the reagent addition/sampling channel 260. In some embodiments, a dilution solution (e.g., phosphate-buffered saline (PBS) or cell culture medium) can be added to the micropores in the detection region via the reagent addition/sampling channel 260 to observe the cell response to the same target compound at different concentrations. The dilution solution may be, for example, phosphate buffered saline (PBS) or cell culture medium.

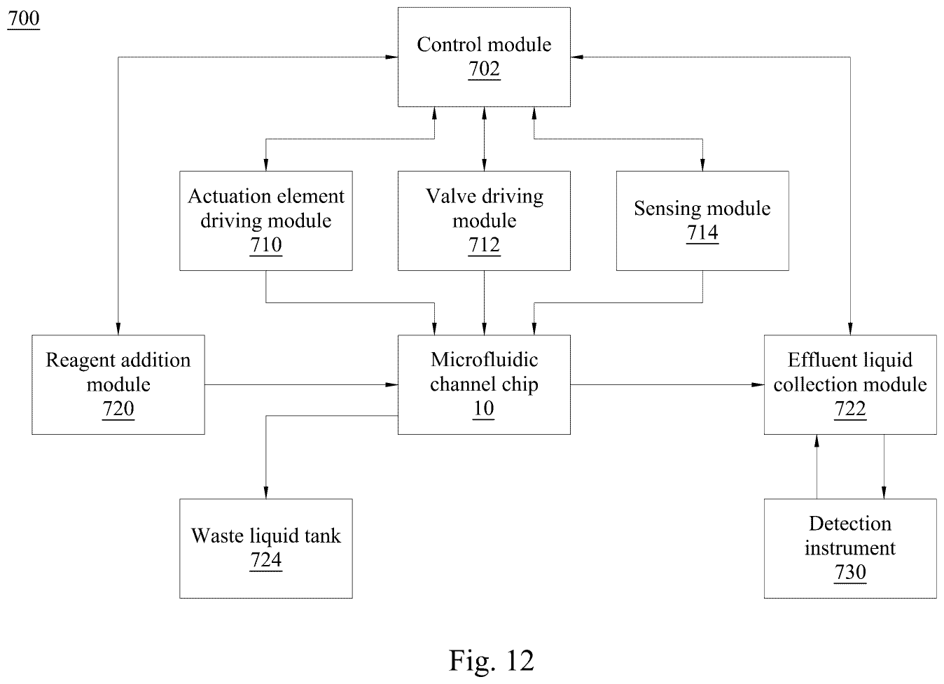

The microfluidic chip 10 further includes a waste liquid channel 270 and a fourth valve element 460. The fourth valve element 460 is configured to control the opening or closing of the waste liquid channel 270. In some embodiments, the initial eluate or eluate from other stages passing through the chromatography column 520 does not contain the target compound, so such eluate is directed out of the microfluidic chip 10 via the waste liquid channel 270 and into an external waste liquid tank (724, see FIG. 12).

As shown in the layout of FIG. 7, the liquid channel system 540, reagent addition/sampling channel 260, and waste liquid channel 270 are all connected to the second filter cavity 532 of the second filtering element 530. When the liquid flows out of the chromatography column 520 and reaches the second filter cavity 532 of the second filtering element 530, the liquid is directed into one of the liquid channel system 540, reagent addition/sampling channel 260, or waste liquid channel 270 by controlling the third valve element 450 and the fourth valve element 460.

In some embodiments, as shown in FIGS. 1 to 7, the liquid channel system 540 includes a main channel 542, a plurality of primary branch channels 544, and a plurality of secondary branch channels 546. The main channel 542 branches into the plurality of primary branch channels 544. Each primary branch channel 544 branches into the plurality of secondary branch channels 546. The liquid channel system 540 is configured to deliver the liquid (e.g., the liquid containing the separated compounds) to each micropore 554 in the detection region 550.

As shown in FIG. 2, the detection region 550 may include a plurality of sub-detection regions 552, such as a first sub-detection region 552A, a second sub-detection region 552B, a third sub-detection region 552C, and a fourth sub-detection region 552D. Although four sub-detection regions are illustrated, the present disclosure may include more or fewer sub-detection regions. Each sub-detection region 552 includes a plurality of micropores 554. For example, the first sub-detection region 552A includes a plurality of first micropores 554A, the second sub-detection region 552B includes a plurality of second micropores 554B, the third sub-detection region 552C includes a plurality of third micropores 554C, and the fourth sub-detection region 552D includes a plurality of fourth micropores 554D. Although four micropores are illustrated per sub-detection region, the sub-detection regions of the present disclosure may include more or fewer micropores.

In some embodiments, cells (e.g., artificially cultured cell lines) are added to the micropores 554 to detect cell responses to the separated compounds. For example, cells of different cancer cell lines may be added to different micropores 554. After co-culturing with the separated compounds for a period (e.g., several hours to days), the viability and morphological changes of the cells in each micropore 554 can be observed using optical instruments. In some embodiments, fluorescence microscopy can be used to detect fluorescence in the micropores. In some embodiments, electrochemical signals in the micropores can be detected. In some embodiments, the liquid in the micropores 554 may be directed out of the microfluidic chip 10 to an external effluent liquid collection module (722, see FIG. 12) via the reagent addition/sampling channel 260 and the control of the third valve element 450, allowing the detection of secretory products after co-culturing the cells with the separated compounds. In some embodiments, liquid chromatographs, gas chromatographs, mass spectrometers, etc., may be used to monitor the time-dependent quantities of the specific secretory products. In other embodiments, antibodies, colorimetric reagents, signal detection elements, or combinations thereof may be placed in each micropore 554 to detect or screen compounds with specific reactive properties.

As shown in FIGS. 4 and 7, in some embodiments of the present disclosure, a heating and weighing assembly 110 is disposed under the processing chamber 430 to heat and weigh the liquid in the processing chamber 430. As shown in FIG. 4, the heating and weighing assembly 110 is located in the substrate layer 100 and includes a heating element 110A, a weighing element 110B, and electrodes 112. In other embodiments, either the heating element 110A or the weighing element 110B may be included.

In some embodiments, the heating element 110A is used to concentrate the extraction solution for the sample by evaporating a portion of the extraction solvent before introducing the extraction solution into the subsequent first filtering element 510 and chromatography column 520. During heating, the first valve element 420 may be opened to allow the evaporated extraction solvent to exit the microfluidic chip 10 via the first valve element 420.

In some embodiments, the weighing element 110B includes piezoelectric material to sense the weight of the fluid in the processing chamber 430. The weighing element 110B is used to determine the weight of the extraction solution before it enters the chromatography column. Determining the weight of the extraction solution may be used to test and adjust the operational conditions and compound separation effectiveness of the microfluidic chip 10.

In some embodiments, the heating and weighing assembly 110 includes the heating element 110A and the weighing element 110B made of piezoelectric material and disposed on the heating element 110A.

Referring to FIGS. 1, 7, and 8A to 8C, in some embodiments of the present disclosure, the flow of liquid in the microfluidic chip 10 is primarily driven by the actuation element 470 over the processing chamber 430, and the direction of flow from the processing chamber 430 toward the sample loading chamber 410 or the first filtering element 510 can be controlled by adjusting the opening or closing of the first valve element 420 or the second valve element 440. The rising of the actuation element 470 creates a negative pressure in the processing chamber 430, causing the liquid to flow into the processing chamber 430 when the first valve element 420 is open. The pressing down of the actuation element 470 creates a positive pressure in the processing chamber 430, causing the liquid to flow outward when the first valve element 420 or the second valve element 440 is open.

In some embodiments, after mixing the sample and the extraction solution via suction and vortex, the first valve element 420 is closed, and the second valve element 440 is opened to allow the liquid to flow into the first filtering element 510, followed by pressurization to direct the liquid into the chromatography column 520. Subsequently, further pressurization is applied to drive the liquid into the second filtering element 530. After the liquid exits the second filtering element 530, the target compound may be screened using the time difference of outflow. The liquid can be discharged via the reagent addition/sampling channel 260, or the third valve element 450 can be closed, and pressurization is applied to allow the liquid to enter the liquid channel system 540, delivering the compounds to the micropores 554 in the detection region 550.

In embodiments of the present disclosure, integrating the processing chamber 430 and the chromatography column 520 into the microfluidic chip 10 not only improves the integration of functional elements but also eliminates dead volume caused by interfaces and avoids sample loss and contamination during offline processing. Additionally, in some embodiments, sample concentration and weight determination can be performed in the processing chamber 430 before chromatography, improving the separation efficiency of the chromatography. Furthermore, liquid flow in the microfluidic chip 10 is controlled by the actuation element 470 and the various valve elements, and gas pressure can be used to control the elastic membranes, guiding liquid flow by creating positive, negative, or ambient pressure in the liquid channels.

As shown in FIG. 3, the microfluidic chip 10 is a stacked structure, including a substrate layer 100, a first channel layer 200 over the substrate layer, and a second channel layer 300 over the first channel layer. In some embodiments, the substrate layer 100 and the first channel layer 200 may be connected via bonding, and the first channel layer 200 and the second channel layer 300 may also be connected via bonding.

In some embodiments, the material of the substrate layer 100 is transparent and rigid, such as glass, polymethyl methacrylate (PMMA), polycarbonate (PC), polystyrene (PS), acrylonitrile butadiene styrene (ABS), or other polymer plastics. In some embodiments, the thickness of the substrate layer 100 may range from about 0.1 to about 1 millimeter (mm).

In some embodiments, the materials of the first channel layer 200 and the second channel layer 300 are transparent and soft, such as polydimethylsiloxane (PDMS). In some embodiments, the thickness of the first channel layer 200 may range from about 0.1 to about 1 mm, and the thickness of the second channel layer 300 may range from about 1 to about 10 mm. In some embodiments, the thickness of the first channel layer 200 may be approximately equal to the thickness of the second channel layer 300, or the thickness of the first channel layer may be less than the thickness of the second channel layer 300.

In some embodiments, the sample loading chamber 410, disposed over the second channel layer 300, may have chamber walls 412 having a height of 10 to 100 mm to accommodate biological materials for extraction. During the extraction process, the driving membrane 280 repeatedly flows and mixes the extraction solution from the processing chamber 430 into the sample loading chamber 410. Therefore, in order to accommodate the biological material and the extraction solution while preventing the liquid overflow, the sample loading chamber 410 is designed to have a larger space; for example, the area of the sample loading chamber 410 is greater than the area of the processing chamber 430 or the surface area of the driving membrane 280. In some embodiments, to reserve sufficient space for chromatography and sample detection, the area of the sample loading chamber 410 is less than about 5% of the total area of the microfluidic chip 10.

Referring to FIGS. 1, 3, and 4, the substrate layer 100 is at the bottom of the microfluidic chip 10. The substrate layer 100 serves as the bottom surface for the openings or the downward-facing recesses in the first channel layer 200.

As shown in FIG. 4, the heating and weighing assembly 110 and the electrodes 112 connected to the heating and weighing assembly 110 are disposed in the substrate layer 100, used to evaporate part of the solvent and determine the weight of the extraction solution before chromatography.

Referring to FIGS. 1, 3, and 5, in some embodiments, recesses for liquid flow are defined in the first channel layer 200, corresponding to the liquid channel system 540. As shown in FIG. 11, a cross-sectional view along line E-E′ of the microfluidic chip 10 in FIG. 7, spanning four secondary branch channels 546 (i.e., two first secondary branch channels 546A and two second secondary branch channels 546B). The recesses for liquid flow are concave downward with upward openings, with the bottom surface of the second channel layer 300 serving as the upper surface of the liquid channel system 540.

FIG. 11 also shows that the first secondary branch channels 546A and the second secondary branch channels 546B have different widths. The first secondary branch channels 546A have shorter paths, delivering the liquid to the micropores 554A in the first sub-detection region 552A and the micropores 554B in the second sub-detection region 552B. The second secondary branch channels 546B have longer paths, delivering the liquid to the micropores 554C in the third sub-detection region 552C and the micropores 554D in the fourth sub-detection region 552D. The width W1 of the first secondary branch channels 546A is greater than the width W2 of the second secondary branch channels 546B. In some embodiments, the width W1 may range from about 1 to 2 mm, while the width W2 may be less than 10 to 100 micrometers (e.g., 20 micrometers). The larger width W1 reduces resistance of the liquid in the first secondary branch channels 546A, allowing faster delivery to the first sub-detection region 552A and the second sub-detection region 552B, which are closer to the opening of the chromatography column 520. When the micropores in the first sub-detection region 552A and the second sub-detection region 552B are filled, the liquid begins flowing into the higher-resistance second secondary branch channels 546B, delivering the liquid to the micropores in the third sub-detection region 552C and the fourth sub-detection region 552D. This design allows compounds eluting from the chromatography column 520 at different time intervals to be respectively directed into the micropores 554 in different sub-detection regions.

The first channel layer 200 further includes a first sample loading opening 210, a processing chamber recess 220, a first filter recess 230 for accommodating the first filter 514 of the first filtering element 510, a second filter recess 232 for accommodating the second filter 534 of the second filtering element 530, the reagent addition/sampling channel 260, the waste liquid channel 270, and multiple first micro-through holes 254 in the detection region 550. An opening 262 is also defined in the first channel layer 200, and the opening 262 is in communication with the reagent addition/sampling channel 260. An opening 272 is also defined in the first channel layer 200, and the opening 272 is in communication with the waste liquid channel 270.

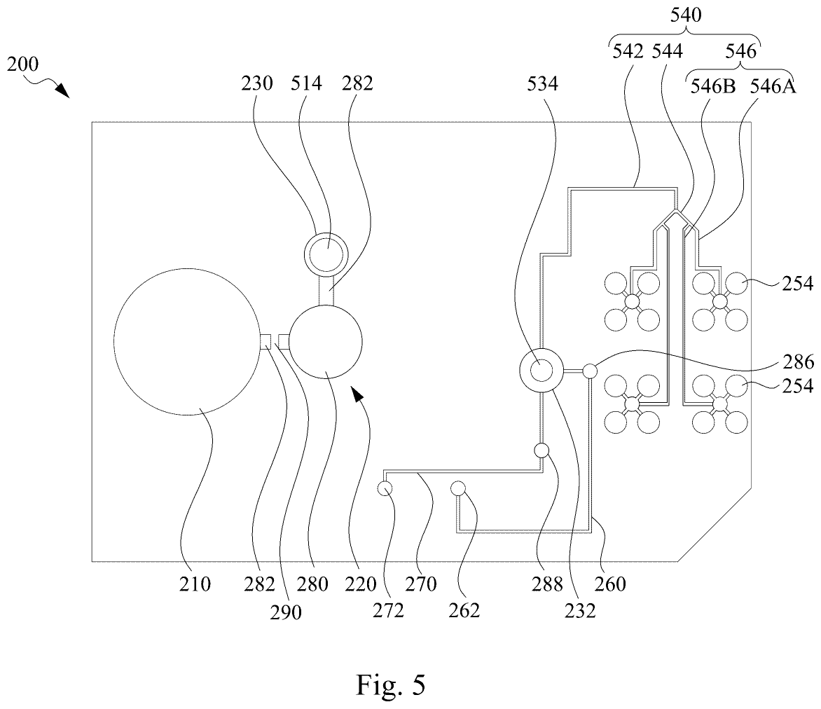

The first channel layer 200 further includes hollowed-out regions where the upper parts are thin films and the lower parts are recesses. Since the material of the first channel layer 200 is made of PDMS, the thin films are deformable and elastic. Thus, by raising or lowering the thin films, negative or positive pressure can be created in the flow channels or processing chamber beneath the thin membrane, driving the fluid flow in the microfluidic chip 10. In some embodiments, the thin film regions of the first channel layer 200 include the driving membrane 280 of the actuation element 470 over the processing chamber 430 (i.e., the processing chamber recess 220) and the elastic membranes respective on the various valve elements. As shown in FIG. 5, the first channel layer 200 has a first elastic membrane 282 at the position of the first valve element 420, a second elastic membrane 284 at the position of the second valve element 440, a third elastic membrane 286 at the position of the third valve element 450, and a fourth elastic membrane 288 at the position of the fourth valve element 460.

In some embodiments, the valve elements on either side of the processing chamber have valve pillars to completely block the liquid flow when the valve elements are closed. For example, when the actuation element 470 generates vortices to the sample and extraction solvent, the second valve element 440 need to be closed to prevent air from the side of the first filtering element 510 from being drawn into the processing chamber 430, which could create bubbles. Referring to FIGS. 8A to 8C, the first valve pillar 290 of the first valve element 420 and the first elastic membrane 282 above the first valve pillar 290 are defined in the first channel layer 200, and the second valve pillar 292 of the second valve element 440 and the second elastic membrane 284 above the second valve pillar 292 are defined in the first channel layer 200. The bottom surfaces of the first valve pillar 290 and the second valve pillar 292 are not connected to the substrate layer 100. The deformation of the elastic membranes causes the valve pillars to contact or separate from the substrate layer 100, thereby closing or opening the valve elements.

In some embodiments, the third elastic membrane 286 of the third valve element 450 and the fourth elastic membrane 288 of the fourth valve element 460 are defined at the first channel layer, and no valve pillar is provided. When the third elastic membrane 286 of the third valve element 450 is not deformed, the reagent addition/sampling channel 260 below keeps the flow channel open; if it is necessary to close the reagent addition/sampling channel 260, positive pressure is introduced to press the third elastic membrane 286 down to close the flow channel. Similarly, when the fourth elastic membrane 288 of the fourth valve element 460 is not deformed, the lower waste liquid channel 270 keeps the flow channel open; if it is necessary to close the waste liquid channel 270, positive pressure is introduced to press down the fourth elastic membrane 288 down to close the flow channel.

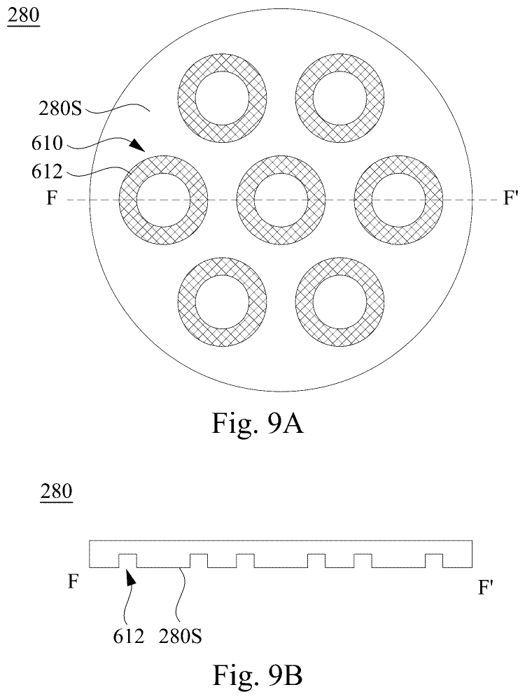

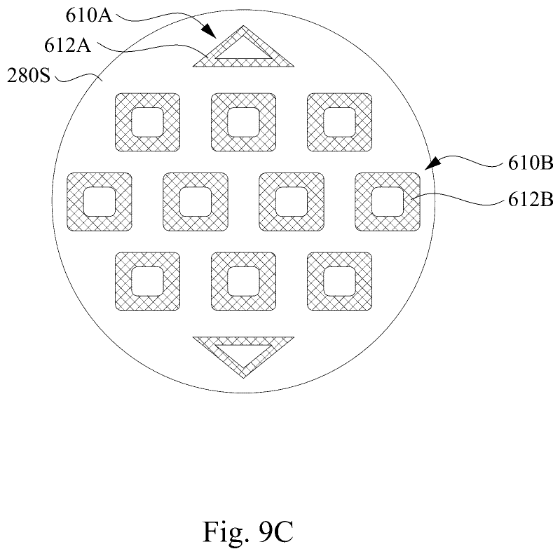

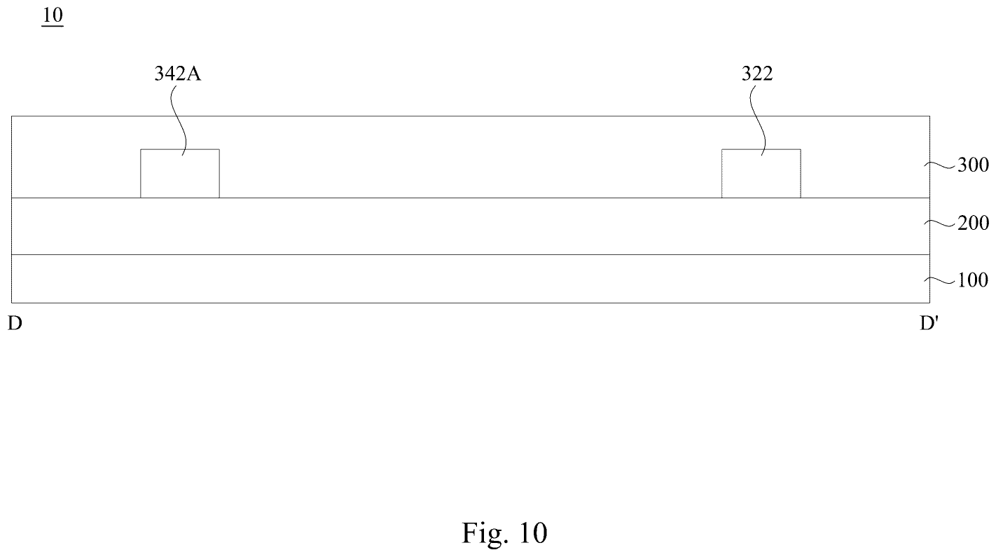

Refer to FIGS. 9A and 9B, which illustrate the driving membrane 280 according to some embodiments. FIG. 9A is a bottom view of the driving membrane 280, and FIG. 9B is a cross-sectional view of the driving membrane 280 along line F-F′. The lower surface 280S of the driving membrane 280 has an uneven structure having multiple patterns 610. In some embodiments, the patterns 610 may include recessed portions, protruding portions, or or a combination thereof. The uneven lower surface 280S of the driving membrane 280 enhances turbulence when the membrane is repeatedly deformed to mix the sample and extraction solvent to enhance the mixing efficiency of the sample and extraction solvent. In some embodiments, the patterns 610 may include recessed portions 612. In some embodiments, the depth of the recessed portions may be about ⅓ to ⅔ of the thickness of the driving membrane 280. In FIG. 9A, the recessed portions 612 are ring-shaped. In other embodiments, as shown in FIG. 9C, the lower surface 280S of the driving membrane 280 has various patterns, including triangular patterns 610A having recessed portions 612A and rectangular patterns 610B having recessed portions 612B. In other embodiments, the lower surface 280S of the driving membrane 280 may have other shapes, such as polygons (e.g., triangles, quadrilaterals, pentagons, hexagons, octagons, etc.), ellipses, irregular shapes, or combinations thereof. In other embodiments, the lower surface 280S of the driving membrane 280 may also include more or fewer recessed portions 612.

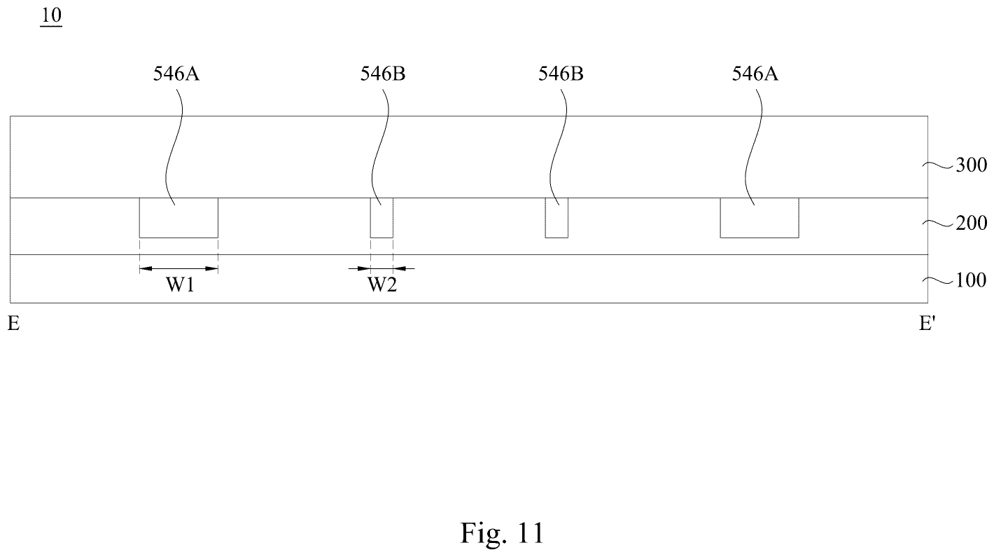

Referring to FIGS. 1, 3, and 6, in some embodiments, a plurality of recesses for gas flow and vent holes are defined in the second channel layer 300, and the positions of these recesses correspond to the gas channels, and the vent holes are the positions where the microfluidic chip operation system 700 (see FIG. 12) introduces gas into the microfluidic chip 10. In some embodiments, as shown in FIG. 10, a cross-sectional view along line D-D′ of the microfluidic chip 10 in FIG. 7, the recesses for gas flow are concave upward and open downward, with the top surface of the first channel layer 200 serving as the lower surface of the gas channels. In some embodiments, an inflow/outflow port 362 and a waste liquid outlet 372 are also defined in the second channel layer 300, corresponding to the opening 262 and the opening 272 in the first channel layer 200, respectively.

Referring to the layout of FIG. 7 and the cross-sectional views in FIGS. 8A to 8C, in some embodiments, the recesses for gas flow include a driving control recess 320 over the driving membrane 280 of the processing chamber 430 and a driving gas channel 322 connected to the driving control recess 320. The second channel layer 300 further includes a driving gas vent 324 in communication with the driving gas channel 322.

In some embodiments, the recesses for gas flow also include valve control recess over each valve and elastic membrane, as well as valve gas channels in communication with the valve control recesses. The second channel layer 300 further includes valve gas vents, each connected to the valve gas channels.

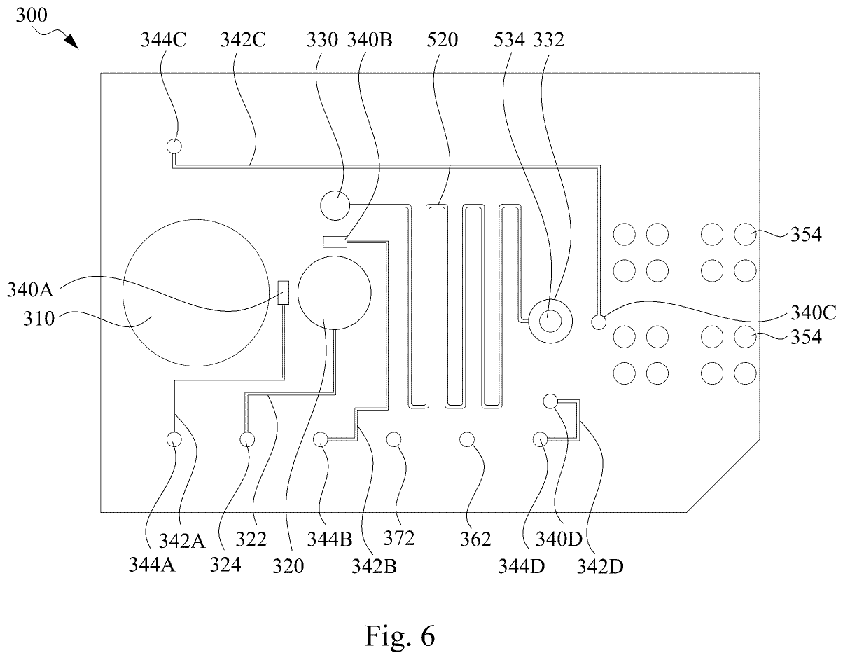

As shown in FIGS. 6 and 7, at the first valve element 420, a corresponding first valve control recess 340A is defined in the second channel layer 300. Also, a first valve gas channel 342A communicating with the first valve control recess 340A and a first valve vent 344A communicating with the first valve gas channel 342A are defined in the second channel layer 300. At the second valve element 440, a corresponding second valve control recess 340B is defined in the second channel layer 300. Also, a second valve gas channel 342B communicating with the second valve control recess 340B and a second valve vent 344B communicating with the second valve gas channel 342B are defined in the second channel layer 300. At the third valve element 450, a corresponding third valve control recess 340C is defined in the second channel layer 300. Also, a third valve gas channel 342C communicating with the third valve control recess 340C and a third valve vent 344C communicating with the third valve gas channel 342C are defined in the second channel layer 300. At the fourth valve element 460, a corresponding fourth valve control recess 340D is defined in the second channel layer 300. Also, a fourth valve gas channel 342D communicating with the fourth valve control recess 340D and a fourth valve vent 344D communicating with the fourth valve gas channel 342D are defined in the second channel layer 300.

The second channel layer 300 further includes a second sample loading opening 310, a third filter recess 330 for accommodating the first filter 514 of the first filtering element 510, a fourth filter recess 332 for accommodating the second filter 534 of the second filtering element 530, and multiple second micro-through holes 354 in the detection region 550.

The first filtering element 510 and the second filtering element 530 are respectively disposed at either end of the chromatography column 520 and are used to filter out impurities in the liquid. For example, the first filtering element 510 prevents impurities from entering the chromatography column 520. The second filtering element 530 prevents the filling material (e.g., beads) of the chromatography column 520 from flowing out into the detection region 550. In some embodiments, the materials of the first filter 514 of the first filtering element 510 and the second filter 534 of the second filtering element 530 may include filter paper, cotton, chemical fibers, microchannel structures, etc. In some embodiments, the pore sizes of the first filtering element 510 and the second filtering element 530 may range from 0.01 to 10 micrometers.

The second channel layer 300 also includes the chromatography column 520, which contains filling material to adsorb specific compounds in the extraction solution. In some embodiments, the filling material may include silica gel, alumina, activated carbon, polyamide, macroporous adsorption resin, cross-linked dextran gel, agarose gel, polyacrylamide gel, polystyrene gel, metal-organic framework materials, or the like.

In some embodiments, the first channel layer 200 and the second channel layer 300 may be formed using three-dimensional molding to create the openings, recesses, and hollowed-out portions in the first channel layer 200 and the second channel layer 300.

In some embodiments, after forming the openings and recesses in the second channel layer 300, filling material is introduced into the chromatography column 520 in the second channel layer 300.

In some embodiments, the substrate layer 100 and the first channel layer 200 are bonded via plasma bonding. Subsequently, the first filter 514 and the second filter 534 are placed in the first filter recess 230 and the second filter recess 232 of the first channel layer 200, respectively. Then, the first channel layer 200 and the second channel layer 300 are bonded via plasma bonding.

Referring to FIGS. 3 and 7, the figures illustrate the structural configuration relationships of the layers in various regions after assembling the substrate layer 100, the first channel layer 200, and the second channel layer 300.

The positions of the first sample loading opening 210 in the first channel layer 200 and the second sample loading opening 310 in the second channel layer 300 correspond to the sample loading chamber 410, with the upper surface of the substrate layer 100 serving as the bottom surface of the sample loading chamber 410. The sample loading chamber 410 further includes chamber walls 412 disposed above the second channel layer 300.

The positions of the valves and elastic membranes in the first channel layer 200 and the valve control recesses in the second channel layer 300 correspond to the valve elements.

The positions of the processing chamber recess 220 and the driving membrane 280 in the first channel layer 200 and the driving control recess 320 in the second channel layer 300 correspond to the processing chamber 430.

The positions of the multiple first micro-through holes 254 in the first channel layer 200 and the multiple second micro-through holes 354 in the second channel layer 300 respectively correspond to the multiple micropores 554 in the detection region 550.

FIGS. 8A to 8C show cross-sectional views along the line A-B and the line B-C in FIG. 7, showing a schematic diagram of a region including the sample loading chamber 410, the first valve element 420, the processing chamber 430, and the second valve element 440, with liquid 20 under different gas pressure control states.

FIG. 8A illustrates the first elastic membrane 282 of the first valve element 420 at an equilibrium position under ambient pressure, with the first valve pillar 290 and the second valve pillar 292 in a closed state. The actuation element 470 (i.e., the driving membrane 280) is also at the equilibrium position under ambient pressure, with the driving membrane 280 in a flat state.

FIG. 8B shows that when the valve driving module (712 in FIG. 12) of the microfluidic chip operation system applies vacuum suction to the first valve control recess 340A, a negative pressure is created in the first valve control recess 340A, causing the first elastic membrane 282 to rise. As a result, the first valve pillar 290 separates from the substrate layer 100, allowing liquid 20 in the sample loading chamber 410 to flow into the processing chamber 430. Simultaneously, the actuation element driving module (710 in FIG. 12) applies vacuum suction to the driving control recess 320, creating a negative pressure and causing the driving membrane 280 to rise.

FIG. 8C shows that when the actuation element driving module (710 in FIG. 12) of the microfluidic chip operation system applies positive gas pressure to the driving control recess 320, a positive pressure is created in the driving control recess 320, causing the driving membrane 280 to be pressed downward and forcing the liquid 20 to flow back to the sample loading chamber 410 through the first valve pillar 290.

FIG. 12 illustrates a microfluidic chip operation system according to some embodiments of the present disclosure. The microfluidic chip operation system 700 includes the microfluidic chip 10, a control module 702, an actuation element driving module 710, a valve driving module 712, a sensing module 714, a reagent addition module 720, an effluent liquid collection module 722, a waste liquid tank 724, and a detection instrument 730.

The control module 702 controls the operation of each module on the microfluidic chip 10 and receives sensing signals from the sensing module 714.

The actuation element driving module 710 is connected to the driving gas vent 324 of the microfluidic chip 10 and provides positive, negative, or ambient pressure to the driving control recess 320 to adjust the rising or lowering of the actuation element 470 (i.e., the driving membrane 280) over the processing chamber 430.

The valve driving module 712 is connected to the valve vents of the microfluidic chip 10 and provides positive, negative, or ambient pressure to the valve control recesses to adjust the rising or lowering of the elastic membranes of the valve elements, thereby controlling the opening or closing of the valve elements.

The sensing module 714 is electrically connected to the microfluidic chip 10 to receive sensing signals of the microfluidic chip 10 detected by the sensor, such as temperature, pressure, or weight measured from the heating and weighing assembly 110.

The effluent liquid collection module 722 is connected to the inflow/outflow port 362 of the microfluidic chip 10 to collect liquid discharged from the microfluidic chip 10.

The detection instrument 730 is in communication with the effluent liquid collection module 722.

The reagent addition module 720 is in communication with to the inflow/outflow port 362 of the microfluidic chip 10 to deliver reagents to the liquid channel system 540 and the detection region 550.

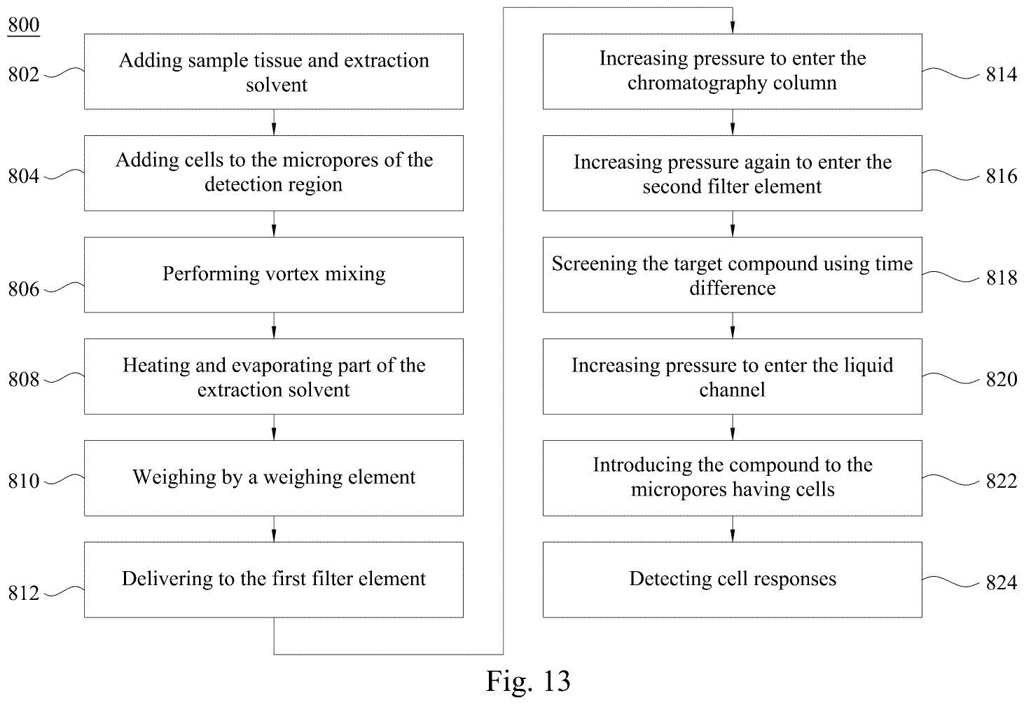

FIG. 13 illustrates a method for using the microfluidic chip 10 according to some embodiments.

In method 800, step 802 involves adding a sample tissue and an extraction solvent. In some embodiments, the sample tissue and the extraction solvent are placed in the sample loading chamber 410. For plant samples, natural compound components have a certain affinity with tissue cells. To dissolve the target components, the extraction solvent needs to have greater affinity to break the adsorption between the target components and the cells, allowing the target components to transfer into the extraction solvent. In some embodiments, the plant sample may be dried (e.g., air-dried) or crushed to improve extraction efficiency. In some embodiments, acids, bases, surfactants, etc., may be added to the extraction solvent to assist desorption and improve the extraction ratio of the target ingredient. The desorbed chemical components are dispersed in the extraction solvent in the form of ions and molecules, and the soluble components are dissolved in the extraction solvent according to their solubility. In some embodiments, depending on the solubility of the target component in the extraction solvent, the extraction solvent may be water, a hydrophilic organic solvent, or a lipophilic organic solvent. In some embodiments, the extraction solvent can be, for example, water, methanol, ethanol, acetone, n-butanol, ethyl acetate, ether, chloroform, dichloroethane, benzene, carbon tetrachloride, petroleum ether, or the like, or a combination thereof. In some embodiments, an auxiliary solvents is also added to increase the solubility of the target component, remove some specific impurities, improve the stability of the component, etc. In some embodiments, the auxiliary solvent may include acids (e.g., hydrochloric acid, sulfuric acid, glacial acetic acid, tartaric acid), bases (e.g., ammonia, carbonic acid acid), or surfactants (e.g., Tween-20, Tween-80).

In step 804, cells are added to the micropores 554 in the detection region 550. In some embodiments, the cells may be cultured in the micropores 554 within the detection regions of the microfluidic chip. In some embodiments, at least a few hours before the extraction (for example, four hours ago), cells are added to a plurality of micropores in the detection region 550, so that the cells are attached to the bottom surfaces of the micropores.

In step 806, the first valve element 420 of the microfluidic chip 10 is opened, and the actuation element 470 is driven to perform vortex mixing in the processing chamber 430. In some embodiments, the second valve element is closed, the first valve element is opened, and the driving membrane of the actuation element is raised. As the volume of the processing chamber becomes larger and the pressure becomes smaller, the fluid in the sample loading chamber flows into the processing chamber. Due to the height limitation of the opening of the first valve pillar of the first valve element, tissue fragments cannot enter the processing chamber. In some embodiments, the penetration of the extraction solvent into the sample tissue and the dissolution of components are increased through repeated suction and vortex. In some embodiments, the mixing time may range from 5 to 30 minutes (e.g., about 20 minutes).

In step 808, part of the extraction solvent in the processing chamber 430 is evaporated by heating to concentrate the extraction solution.

At step 810, the heat and weighing assembly 110 in the processing chamber 430 is used to weigh and determine the weight of the extraction solution for subsequent chromatography.

In step 812, the second valve element 440 is opened to allow the extraction solution to enter the first filtering element 510.

In some embodiments, before opening the second valve element 440, water, buffer solution, or a solvent in which the target components are soluble may be added to the sample loading chamber 410 to ensure sufficient liquid volume for the chromatography column 520.

In step 814, the actuation element 470 is controlled to apply pressure, allowing the extraction solution to enter the chromatography column 520.

In step 816, the actuation element 470 is controlled to increase pressure further, driving the eluate from the chromatography column 520 into the second filtering element 530.

In step 818, the target compound is screened using time differences. At a predetermined collection time, the third valve element 450 is closed to direct the extraction flow into the liquid channel system 540.

In step 820, further pressurization causes the extracted effluent to flow in the liquid channel system 540.

In step 822, the extraction effluent containing the compound is introduced into the micropores 554 containing cells in the detection region 550.

In step 824, after co-culturing the compounds with the cells for a period, cell responses are detected.

One embodiment of the present disclosure provides a method for operating a microfluidic chip, including: adding a sample and an extraction solvent to a sample loading chamber of the microfluidic chip; adding cells to a plurality of micropores in a detection region of the microfluidic chip; driving an actuation element of the microfluidic chip to mix the sample and the extraction solvent, forming an extraction solution; delivering the extraction solution to a chromatography column in the microfluidic chip; delivering at least one target compound of the extraction solution eluted from the chromatography column to the micropores; and detecting the responses of the cells for the at least one target compound.

In some embodiments, the method of using the microfluidic chip further includes: before delivering the extraction solution to the chromatography column, evaporating part of the extraction solvent using a heater in the microfluidic chip.

In some embodiments, the method of using the microfluidic chip further includes: before delivering the extraction solution to the chromatography column, measuring the weight of the extraction solution using a sensor in the microfluidic chip.

In some embodiments, detecting the responses of the cells to the at least one target compound includes: using a detection instrument to detect the secretions of the cells in the plurality of micropores.

Although the present disclosure has been disclosed in many embodiments and examples, it is not intended to limit the present disclosure. Anyone skilled in the art can make various changes and modifications without departing from the spirit and scope of the present disclosure. Therefore, the scope of protection of the present disclosure shall be subject to the scope of the appended claims.

What is claimed is:

1. A microfluidic chip, comprising:
a sample loading chamber, a processing chamber, a first filtering element, a chromatography column, a liquid channel system, and a detection region, sequentially communicated;
a first valve element disposed between the sample loading chamber and the processing chamber;
a second valve element disposed between the processing chamber and the first filtering element; and
an actuation element disposed over the processing chamber, wherein the actuation element comprises a driving membrane, and the actuation element is configured to generate a vortex in the processing chamber and control a pressure within the processing chamber.

2. The microfluidic chip of claim 1, wherein the first valve element comprises a first valve pillar having an opening size ranging from about 5 micrometers to about 30 micrometers.

3. The microfluidic chip of claim 1, wherein a lower surface of the driving membrane has an uneven structure.

4. The microfluidic chip of claim 3, wherein the uneven structure comprises recessed portions.

5. The microfluidic chip of claim 4, wherein a depth of the recessed portions is about ⅓ to about ⅔ of a thickness of the driving membrane.

6. The microfluidic chip of claim 1, further comprising: a heating element disposed under the processing chamber.

7. The microfluidic chip of claim 1, further comprising: a weighing element disposed under the processing chamber.

8. The microfluidic chip of claim 1, further comprising: a second filtering element disposed between the chromatography column and the liquid channel system.

9. The microfluidic chip of claim 1, further comprising:
a reagent addition/sampling channel in communication with the chromatography column; and
a third valve element configured to control a liquid flow direction, opening, or closing of the reagent addition/sampling channel.

10. The microfluidic chip of claim 1, further comprising:
a waste liquid channel in communication with the chromatography column; and
a fourth valve element configured to control opening or closing of the waste liquid channel.

11. The microfluidic chip of claim 1, wherein the microfluidic chip is a stacked structure, comprising:
a substrate layer;
a first channel layer disposed over the substrate layer, wherein a plurality of recesses for liquid flow are defined in the first channel layer; and
a second channel layer disposed over the first channel layer, wherein a plurality of recesses for gas flow are defined in the second channel layer.

12. The microfluidic chip of claim 11, further comprising:
a heating and weighing assembly disposed in the substrate layer and at a bottom of the processing chamber.

13. The microfluidic chip of claim 11, wherein:
the actuation element further comprises a driving control recess disposed over the driving membrane, wherein the processing chamber and the driving membrane are disposed in the first channel layer, and the driving control recess is disposed in the second channel layer.

14. The microfluidic chip of claim 11, wherein the first valve element comprises:
a first valve pillar, disposed between the sample loading chamber and the processing chamber and disposed in the first channel layer;
a first elastic membrane disposed above the first valve pillar and disposed in the first channel layer; and
a first valve control recess disposed over the first valve pillar and the first elastic membrane and disposed in the second channel layer.

15. The microfluidic chip of claim 11, wherein:
the chromatography column is disposed in the second channel layer.

16. The microfluidic chip of claim 1, wherein a volume of the sample loading chamber is greater than a volume of the processing chamber.

17. The microfluidic chip of claim 1, wherein a lower surface of the driving membrane has a plurality of patterns configured to enhance turbulence, the plurality of patterns comprises recessed portions, protruding portions, or combinations thereof.

18. A microfluidic chip operation system, comprising:
the microfluidic chip of claim 1;
an actuation element driving module configured to control raising and pressed down of the actuation element of the microfluidic chip; and
a valve driving module, configured to control opening or closing of the first valve element and the second valve element.

19. The microfluidic chip operation system of claim 18, further comprising:
a detection instrument, configured to detect a fluid from the chromatography column or the detection region.

20. The microfluidic chip operation system of claim 19, further comprising:
a waste liquid collection module, configured to collect effluent liquid from the chromatography column.
